(19) United States
(12) Patent Application Publication
(10) Pub. No.: US 2013/0089805 A1
(43) Pub. Date: Apr. 11, 2013

(54) ELECTROACTIVE SPECIES IN LAYER BETWEEN ELECTRODE AND MEMBRANE FOR FUEL CELLS

(71) Applicant: University of Central Florida Research Foundation,, Orlando, FL (US)

(72) Inventors: ROBERT PAUL BROOKER, MELBOURNE, FL (US); LEONARD J. BONVILLE, MARLBOROUGH, CT (US)

(73) Assignee: University of Central Florida Research Foundation, Inc., Orlando, FL (US)

(21) Appl. No.: 13/647,073

(22) Filed: Oct. 8, 2012

Related U.S. Application Data
(60) Provisional application No. 61/545,709, filed on Oct. 11, 2011.

(51) Int. Cl. H01M 8/10; H01M 8/00

(52) U.S. Cl. 429/480; 429/483; 429/535

(57) ABSTRACT

A membrane electrode assembly (MEA) includes an ion exchange membrane having a polymer, and a first porous layer on its cathode side including a first material different from the polymer having at least one electroactive species providing a reduction potential between 0V and 1V vs. a standard hydrogen electrode at 25° C. adsorbed thereto. A cathode catalyst is on the first porous layer, and an anode catalyst is on the anode side of the ion exchange membrane.

### CROSS REFERENCE TO RELATED APPLICATIONS

This application claims the benefit of Provisional Application Ser. No. 61/545,709 entitled “ELECTROACTIVE SPECIES IN LAYER BETWEEN ELECTRODE AND MEMBRANE FOR FUEL CELLS”, filed Oct. 11, 2011, which is herein incorporated by reference in its entirety.

### U.S. GOVERNMENT RIGHTS

This invention was made with U.S. Government support under Florida Hydrogen Initiative contract #DEFC3604GO14225 awarded by the U.S. Department of Energy. The Government has certain rights in the invention.

### FIELD

Disclosed embodiments relate to electrochemical cells having ion exchange membranes, such as fuel cells, that include electroactive species, such as heteropoly acids (HPAs), within the electrochemical cell.

### BACKGROUND

The performance of a proton exchange membrane (PEM) fuel cell and a direct methanol fuel cell (DMFC) is largely determined by the membrane-electrode assembly (MEA). The MEA comprises an anode that oxidizes the fuel, a cathode that reduces oxygen, and a proton transferring, ion-conducting polymer membrane. The polymer membrane prevents an electrical short-circuit between the anode and the cathode, and provides a separator function that separates the fuel on the anode side from the oxidant on the cathode side.

A PEM fuel cell normally uses H₂ as the fuel, while a DMFC uses methanol (CH₃OH) as the fuel. The terms “fuel cell” or “cell”, as used hereinafter refers to either a PEM or DMFC-type fuel cell. The fuel oxidation reaction and the oxygen reduction reaction of these cells, typically, are kinetically slow. Therefore, catalysts, typically platinum and its alloys, are commonly often used to speed up these reactions.

Conventional fuel cells comprising polymer membranes, such as perfluorosulfonic acid, having platinum catalysts are known to be limited in their lifetime due to membrane degradation during cell operation. It has been demonstrated that platinum can precipitate within the polymer membrane resulting in the formation of a platinum rich area therein that can contribute to accelerated membrane failures.

### SUMMARY

This Summary is provided to introduce a brief selection of disclosed concepts in a simplified form that are further described below in the Detailed Description including the drawings provided. This Summary is not intended to limit the claimed subject matter's scope.

One embodiment comprises a membrane electrode assembly (MEA) including an ion exchange membrane comprising a polymer, and a first porous layer on its cathode side including a first material different from the polymer including at least one electroactive species providing a reduction potential between 0V and 1V vs. a standard hydrogen electrode at 25° C. adsorbed thereto. A cathode catalyst is on the first porous layer, and an anode catalyst is on the anode side of the ion exchange membrane. Disclosed embodiments also include fuel cells including a disclosed MEA, and methods of forming disclosed MEAs including applying an electroactive species ink including a porous support to form a disclosed porous layer including an electroactive species on at least the cathode side of the MEA.

### BRIEF DESCRIPTION OF THE DRAWINGS

FIG. 1A is a cross sectional depiction of an example membrane electrode assembly (MEA) including disclosed porous layers each comprising a material different from the ion exchange membrane polymer which include electroactive species such as heteropoly acids (HPAs) adsorbed to the porous layer, where the porous layers are positioned between the electrodes and the ion exchange membrane, according to an example embodiment.

FIG. 1B is a cross sectional depiction a fuel cell including the MEA shown in FIG. 1A, according to an example embodiment.

FIG. 2 shows the total fluoride released (in μmol) between a control fuel cell having a carbon/ionomer only porous layer, and a disclosed fuel cell including a carbon/ionomer porous layer along with phosphotungstic acid (PTA) used as an example HPA.

FIGS. 3A and 3B are scanned cross-sectional depictions derived from scanning electron microscope (SEM) images of a control fuel cell and a disclosed fuel cell having disclosed HPA/porous layers following a period of operation, respectively, having the resulting ion exchange membrane thicknesses shown.

### DETAILED DESCRIPTION

Disclosed embodiments in this Disclosure are described with reference to the attached figures, wherein like reference numerals are used throughout the figures to designate similar or equivalent elements. The FIGs are not drawn to scale, and they are provided merely for illustration. Several aspects are described below with reference to example applications for illustration.

It should be understood that numerous specific details, relationships, and methods are set forth to provide a full understanding of the disclosed embodiments. One having ordinary skill in the relevant art, however, will readily recognize that the subject matter disclosed herein can be practiced without one or more of the specific details or with other methods. In other instances, well-known structures or operations are not shown in detail to avoid obscuring structures or operations that are not well-known. This Disclosure is not limited by the illustrated ordering of acts or events, as some acts may occur in different orders and/or concurrently with other acts or events. Furthermore, not all illustrated acts or events are required to implement a methodology in accordance with this Disclosure.

Notwithstanding that the numerical ranges and parameters setting forth the broad scope of this Disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

Disclosed embodiments include MEAs which include an added porous layer comprising an electroactive species positioned between at least the cathode and the polymer ion exchange membrane. The electroactive species can comprise a heteropoly acid (HPA), although other electroactive species with a reduction potential between 0V and 1V vs. the standard hydrogen electrode at 25° C. may also be used, such as metal oxides and multivalent ions. Although a disclosed porous layer comprising an electroactive species is not expected to contribute to reducing Pt-band formation on the anode side, disclosed porous layers comprising an electroactive species on the anode side may help to reduce other membrane degradation modes, such as H₂O₂ formation at the anode.

The porous/electroactive species layer comprises a material different from the polymer used in the ion exchange membrane, such as porous carbon. The thickness of the porous/electroactive species layer is generally in a range from 8 μm to 15 μm, with thickness values above and below this range also generally being effective, and thus being part of disclosed embodiments.

As defined herein and known in the chemical arts, HPAs are a class of acid made up of a combination of hydrogen and oxygen with certain metals and non-metals. A heteropoly acid includes a metal such as tungsten, molybdenum or vanadium, termed the “addenda atom”, oxygen, an element generally from the p-block of the periodic table, such as silicon, phosphorus or arsenic termed the “hetero atom”, and acidic hydrogen atoms.

The metal addenda atoms linked by oxygen atoms form a cluster with the hetero- atom inside bonded via oxygen atoms. Example HPAs with more than one type of metal addenda atom in the cluster are well known. One particular example HPA is Phosphotungstic acid (PTA) also known as tungstophosphoric acid (TPA), which is a HPA with the chemical formula H₃PW₁₂O₄₀.

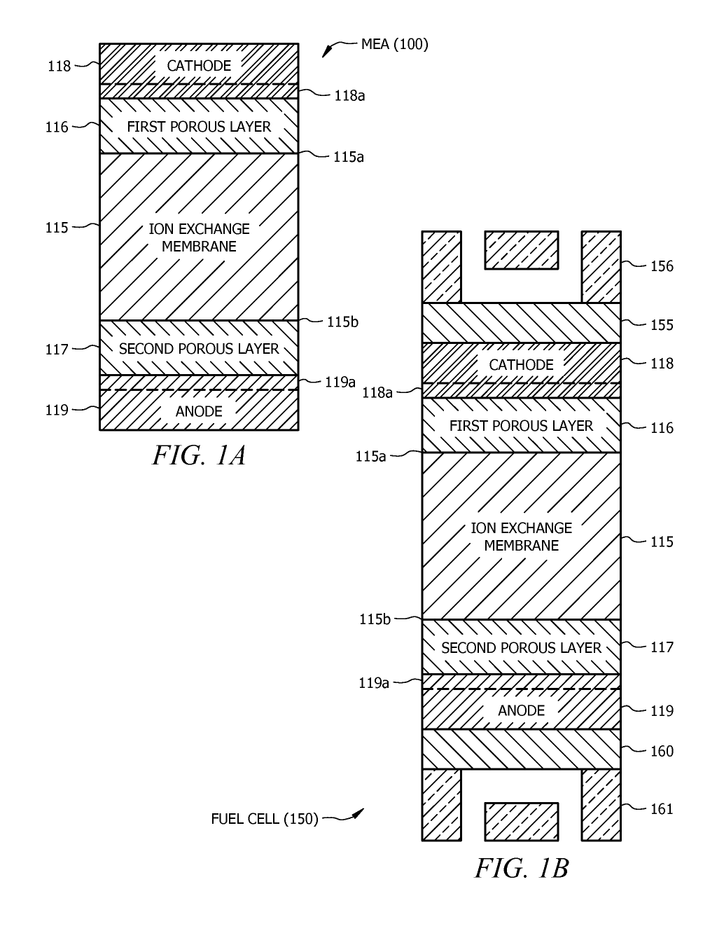

FIG. 1A is a cross sectional depiction of an example MEA 100 according to an example embodiment. MEA 100 comprises a polymer ion exchange membrane 115. The ion exchange membrane 115 typically used in PEM fuel cells comprises a solid polymer electrolyte which has a chemical structure very similar to that of polytetrafluoroethylene (TEFLON). A conventional electrolyte material currently used in PEMFCs is a sulfonated ionomer known as NAFION® that is typically 20 to 150 μm thick. The ion exchange membrane 115 has a cathode side 115(a) and an anode side 115(b).

A first porous layer 116 is on the cathode side comprising a first material different from the polymer used for the ion exchange membrane 115. First porous layer 116 has at least one electroactive species such as HPA molecules adsorbed thereto, generally resulting in a homogenous distribution of electroactive species throughout first porous layer 116. A concentration of electroactive species in the first porous layer 116 can be between 1 to 5 mole percent. However, the concentration of electroactive species can be higher or lower than 1 to 5 mole percent. A second porous layer 117 is shown on the anode side also comprising a material different from the polymer used for the ion exchange membrane 115 referred to herein as a “second material”, also having at least one electroactive species adsorbed thereto. The second material can be the same material or a different material as compared to the first material, and also have a 1 to 5 mole percent concentration.

A cathode 118 including a cathode catalyst layer 118a is on the first porous layer 116, and an anode 119 including anode catalyst layer 119a is on the second porous layer 117. The cathode catalyst layer 118a and anode catalyst layer 119a are generally bonded to the ion exchange membrane 115. The interfaces where the catalyst layers 118a, 119a and ion exchange membrane 115 make contact or are in close proximity of each other are generally referred to as electrode interfaces. A common catalyst material used in PEM fuel cells is platinum, supported by carbon, as it generally provides excellent performance in reaction rates and durability, but also has high cost. Platinum is generally alloyed with other metals, such as cobalt, ruthenium, or iridium to name a few, to improve the durability and performance of the catalyst. Other non-platinum based catalysts may also be possible.

Disclosed porous/electroactive species layers and fuel cells therefrom can be formed using a variety of process flows. In one example process flow, HPAs (or other electroactive species) can be adsorbed onto the carbon surfaces of a porous support material. Supports other than carbon-based supports can also be used, such as silica, and metal oxides such as titania. The supported HPA can then be combined with a solvent and binder (e.g. ionomer), to form an HPA ink. An ink is a mixture of solid materials along with binders and solvents, combined in a controlled process that results in a fluid having specific physical properties required in the case of fuel cells for the fabrication of a catalyst layer.

The HPA ink can then be applied onto a polymer electrolyte membrane, creating an HPA-porous support layer. Once the ink is applied, the solvent is evaporated (e.g., at a fixed rate) to solidify the layer, leaving the HPA, carbon and ionomer. After adding the HPA-porous support layer, a fuel cell anode and cathode that each include catalyst layer, such as comprising platinum on carbon and a binder (e.g. ionomer), can be applied over the respective HPA-porous support layers.

The completed MEA structure, such as MEA 100 shown in FIG. 1A, includes at least one HPA-porous support layer shown as first porous layer 116 between the cathode 118 and the ion exchange membrane 115 and optional second porous layer 117 between the anode 119 and the ion exchange membrane 115 Gas diffusion layers (GDLs) can then be bonded to the cathode 118 and anode 119 of the MEA 100 along with the seals to complete the fuel cell.

FIG. 1B is a cross sectional depiction of a fuel cell 150 including the MEA 100 shown in FIG. 1A, including a cathode GDL 155 and an anode GDL 160. The GDL of a fuel cell performs several important functions with its main purpose to deliver and remove reactants and products to the electrodes. This includes the removal of liquid water which can block the reactions sites on the cathode side of the fuel cell. The GDL also conducts both electrons and heat efficiently from the electrode layers to the flow channel plates. Because of this, the GDL is permeable to hydrogen (for PEMs) and oxygen, electrically and thermally conductive, and mechanically robust. In order to perform all of these functions, the GDL is typically porous. GDLs are usually 100 μm to 400 μm in thickness and are often treated with polytetrafluoroethylene (e.g., TEFLON) or another similar material in order to make them repel water in the case of PEM fuel cells.

A cathode side flow plate 156 is on the cathode GDL 155, and an anode side flow plate 161 is on the anode side GDL 160 to deliver and remove reactants and products from the respective GDLs. The flow plates 156, 161 are typically formed from rigid and electrically conductive plates that give the fuel cell mechanical strength. When several fuel cells are placed in series and are in electrical contact with only one of these plates in-between each cell, these flow plates are referred to as bipolar plates. This is because they simultaneously serve as the anode and cathode plates for two different cells and functionally have two poles. Along with providing an electrically conductive path for electron flow, the bipolar plates give the fuel cell its structure.

Membrane degradation in fuel cells is a generally dominant cause for premature failure, and is often the result of radical attack. It is known that the presence of platinum in a membrane, in connection with molecular H₂ and O₂, will accelerate membrane degradation. Therefore, disclosed embodiments recognize reducing the presence of platinum within the membrane reduces membrane degradation. A mechanism is described below that is believed to explain the observed prevention (or at least reduction) of membrane degradation provided by disclosed porous layers having electroactive species for fuel cells. Although the mechanism described below is believed to be accurate, disclosed embodiments may be practiced independent of the particular mechanism(s) that may be operable which have been verified to prevent (or at least reduce) membrane degradation.

It is believed that by including electroactive species such as HPAs with the disclosed first porous layer 116, ionic platinum (or metal ions from other catalysts) that are dissolved at the cathode 118/cathode catalyst 118a of the fuel cell are reduced to metallic platinum as the platinum ion diffuses through the first porous layer 116 via the reduction/oxidation properties of the electroactive species, such as HPA. Crossover hydrogen (H₂) can reduce oxidized HPA (HPA_{O}⁻ⁿ) in the disclosed first porous layer 116 , forming HPA_{R} compounds in a first process step, which are then available to reduce ionic platinum (platinum cations) to form metallic platinum in a second process step. This is shown through the following two-step reaction scheme:

H₂+HPA_{O}⁻ⁿ→2H⁺+HPA_{R}⁻⁽ⁿ⁺²)

HPA_{R}⁻⁽ⁿ⁺²⁾+Pt^{x+}→HPA_{O}⁻ⁿ+Ptₛ

Experiments have shown that the reduction and oxidation of HPAs are often electrochemically reversible, indicating facile transfer of charge to and from the HPA molecule. Thus, as ionic platinum diffuses through a disclosed first porous layer 116, the ionic platinum will be reduced to metallic platinum in the vicinity of the HPA (i.e. within the first porous layer 116). By reducing the platinum ions within the disclosed first porous layer 116, membrane degradation can be mitigated through minimization of platinum band formation.

It is desirable to maintain the electroactive species such as HPAs in position in their respective porous layers 116, 117. For example, to reduce the mobility of the electroactive species such as HPAs within the fuel cell, the HPAs can be adsorbed onto porous supports such as porous carbon supports, which have been shown to effectively retain HPAs. A carbon support is one which is resistant to corrosion, e.g., graphitized carbon, engineered carbon, or nano carbon. However, in the tests performed to validate disclosed approaches, commercially available carbon, VULCAN® XC-72R carbon black (Cabot Corporation, Billerica, Mass.), which is a powdered carbon black having a typical bulk density of 6 lbs/ft³ was used. This carbon is less stable than other forms of carbon, but is well characterized. The HPA adsorption process was provided by soaking the XC-72R carbon black in a solution of HPA and water over three days, followed by filtering.

Tests were performed on fuel cells manufactured to contain disclosed porous carbon support layers including an ionomer and HPA, along with a control fuel cell comprising just a porous carbon support layer and ionomer (no HPA). The disclosed porous support layers including HPA were formed by soaking a porous carbon support in a solution including phosphotungstic acid (PTA, H₃PW₁₂O₄₀).

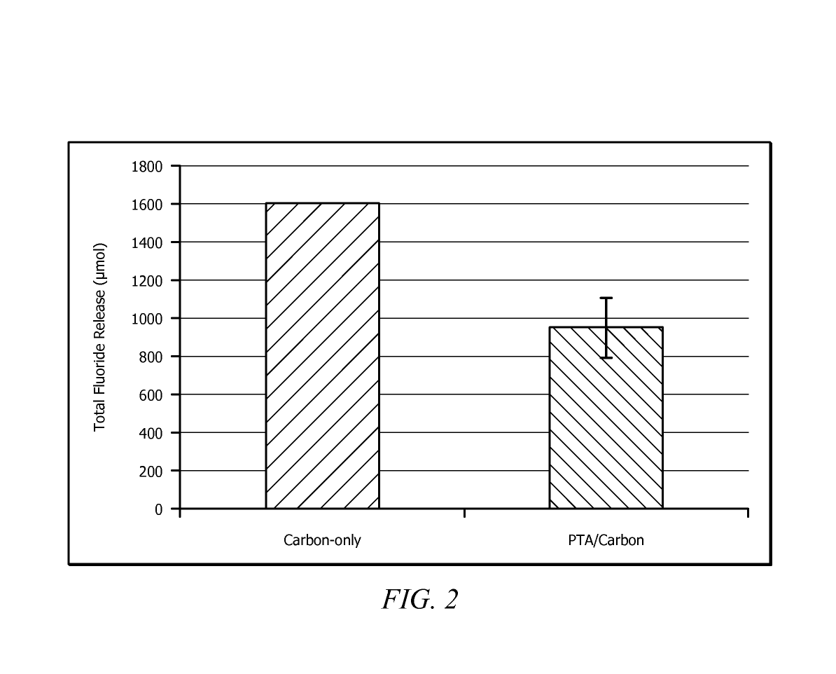

The respective fuel cells were both subjected to an accelerated stress test (AST), where the fuel cells were held at an open circuit voltage between about 0.90V and 0.95V (defined by the oxygen and hydrogen concentrations, the humidity of the inlet gas, the catalyst, presence of contaminants, and the integrity of the ion exchange membrane) for 100 hours at 90° C./30% relative humidity (RH) with H₂/air as the reactant gases. The definition of “open circuit voltage” includes the conditions of the test, and the cells are operated without drawing current, leaving the voltage to climb to whatever value it can. Throughout the stress test, the open circuit voltage is known to change as the surface of the catalyst and the integrity of the ion exchange membrane change. During the stress test, the concentration of fluoride in the effluent water (an indicator of membrane degradation) was recorded, and plotted as total amounts of fluoride released. FIG. 2 shows the total fluoride released (in μmol) between a control fuel cell having a carbon/ionomer only porous layer (shown as “Carbon-only”), and a disclosed fuel cell having a carbon/ionomer porous layer with PTA (shown as “PTA/carbon”). As shown in FIG. 2, the addition of PTA to the porous layer reduced the amount of fluoride lost by the ion exchange membrane by nearly half, when compared to the control fuel cell with only porous carbon and ionomer in the porous layers.

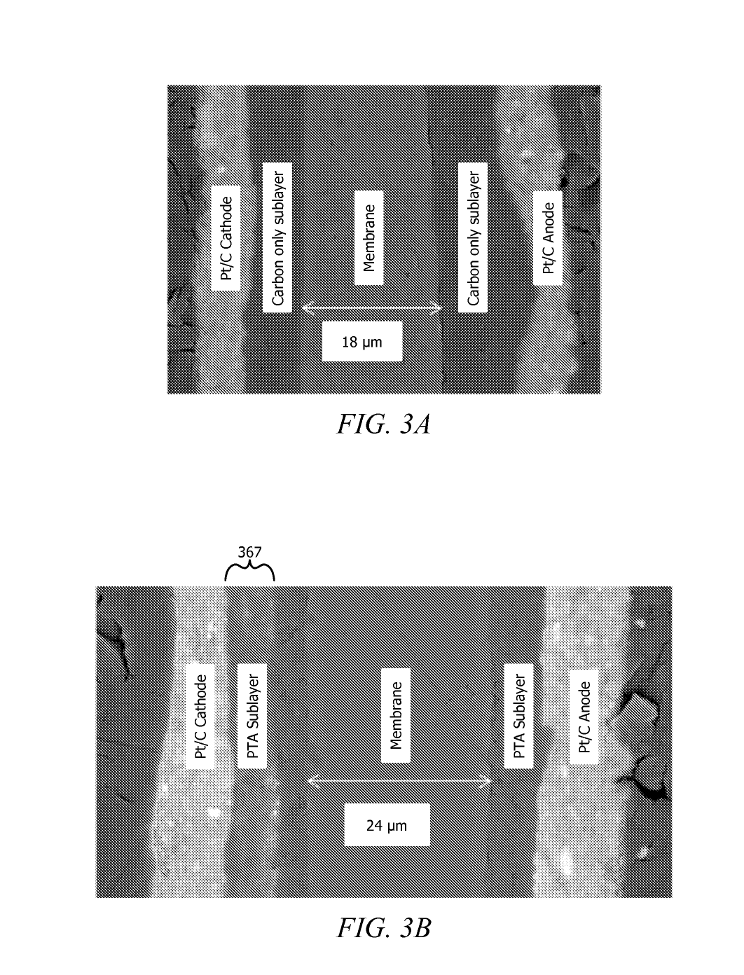

Additional evidence of reduced membrane degradation is shown in FIGS. 3A and 3B, where the cross-sections of the control fuel cell (shown as “Carbon only”) and a fuel cell having disclosed HPA/porous layers (shown as “PTA/carbon”) are respectively shown with the respective membrane thicknesses following operation shown. It is noted that the initial (i.e. before testing) ion exchange membrane thickness was 25 μm. As can be seen, for the control fuel cell having a carbon-only porous layer shown in FIG. 3A, the ion exchange membrane was thinned considerably more (thinned 24% from 25 μm to about 18 μm) as compared to the disclosed fuel cell having porous layers comprising PTA and porous carbon shown in FIG. 3B (4% from 25 μm to 24 μm). In addition, a bright band identified as reference 367 was found to be present in the PTA/carbon layer, which is likely to be due to the presence of platinum, since platinum within the electrode appears similar to the band seen in the PTA/carbon layer.

As described and demonstrated above, disclosed embodiments provide prevention, or at least substantial reduction, of catalyst ions formed during operation, such as platinum, from precipitating within the ion exchange membrane 115. Disclosed embodiments can generally be used for all fuel cells that employ platinum catalyst in the cathode, and can serve to significantly increase the lifetime of the ion exchange membrane. By increasing the membrane lifetime, fuel cells can gain wider commercialization.

Although the primary anticipated use for disclosed embodiments is for fuel cells, disclosed embodiments can be used for in other types of electrochemical cells. For example, there may be degradation modes active in other types of electrochemical cells (e.g. electrolysis) that can benefit from disclosed embodiments.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

Thus, the breadth and scope of the subject matter provided in this Disclosure should not be limited by any of the above explicitly described embodiments. Rather, the scope of this Disclosure should be defined in accordance with the following claims and their equivalents.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

We claim:

1. A membrane electrode assembly (MEA), comprising:
an ion exchange membrane comprising a polymer having a cathode side and an anode side;
a first porous layer on said cathode side comprising a first material different from said polymer having at least one electroactive species providing a reduction potential between 0V and 1V vs. a standard hydrogen electrode at 25° C. adsorbed thereto;
a cathode catalyst on said first porous layer, and
an anode catalyst on said anode side of said ion exchange membrane.

2. The MEA of claim 1, further comprising a second porous layer between said anode catalyst and said anode side of said ion exchange membrane comprising a second material different from said polymer having said electroactive species adsorbed thereto.

3. The MEA of claim 1, wherein said ion exchange membrane comprises perfluorosulfonic acid.

4. The MEA of claim 2, wherein said first porous layer and said second porous layer both comprise porous carbon.

5. The MEA of claim 2, wherein said cathode catalyst and said anode catalyst both comprise platinum.

6. The MEA of claim 1, wherein said electroactive species comprises at least one heteropoly acid (HPA).

7. A fuel cell, comprising:
a membrane electrode assembly (MEA), including:
an ion exchange membrane comprising a polymer having a cathode side and an anode side;
a first porous layer on said cathode side comprising a first material different from said polymer having at least one electroactive species providing a reduction potential between 0V and 1V vs. a standard hydrogen electrode at 25° C. adsorbed thereto;
a cathode including a cathode catalyst on said first porous layer, and
an anode including an anode catalyst on said anode side of said ion exchange membrane;
an anode side gas diffusion layer (GDL) on said anode and anode side flow plates on said anode side GDL, and
a cathode side GDL on said cathode and cathode side flow plates on said cathode side GDL.

8. The fuel cell of claim 7, wherein said fuel cell comprises a proton exchange membrane (PEM) fuel cell, and wherein said electroactive species comprises at least one heteropoly acid (HPA).

9. The fuel cell of claim 7, wherein said cathode catalyst and said anode catalyst both comprise Pt.

10. A method of forming a membrane electrode assembly (MEA), comprising:
applying an electroactive species to porous support particles to form a supported electroactive species, combining said supported electroactive species with a solvent and a binder to form an electroactive species ink;
applying said electroactive species ink onto a polymer electrolyte membrane to form an electroactive-support layer on at least a cathode side of said polymer electrolyte membrane;
applying a cathode including a cathode catalyst on said electroactive-support layer on said cathode side, and
applying an anode including an anode catalyst on said anode side.

11. The method of claim 10, wherein said applying said electroactive species ink further comprises forming said electroactive-support layer on said anode side of said polymer electrolyte membrane before said applying said anode.

12. The method of claim 10, wherein said porous support comprises a carbon support.

13. The method of claim 10, wherein said binder comprises an ionomer.

14. The method of claim 10, wherein said electroactive species comprises at least one heteropoly acid (HPA).
